(19) United States
(12) Patent Application Publication
(10) Pub. No.: US 2003/0077495 A1
(43) Pub. Date: Apr. 24, 2003

(54) Fuel cell system, and method of testing a fuel cell for a gas leak

(76) Inventors: John P. Scartozzi, Spokane, WA (US); Scott Spink, Spokane, WA (US); Peter D. DeVries, Tekoa, WA (US)

Correspondence Address: WELLS ST. JOHN ROBERTS GREGORY & MATKIN P.S., 601 W. FIRST AVENUE, SUITE 1300, SPOKANE, WA, 99201-3828, US

(21) Appl. No.: 10/010,662

(22) Filed: Oct. 19, 2001

(51) Int. Cl. H01M 8/04; H01M 8/10

(52) U.S. Cl. 429/25; 429/30; 429/13

(57) ABSTRACT

A method of testing a fuel cell for gas leaks comprises providing a gas sensor in gas sensing relation to the fuel cell system, and initiating a pressure test of the fuel cell in response to the gas sensor sensing more than a predetermined amount of a target gas. A fuel cell power system comprises a fuel cell defining a fluid vessel having a fuel inlet and bleed outlet; a fuel valve upstream of the fuel inlet; a bleed valve downstream of the fuel outlet; and a pressure transducer in fluid communication with the fluid vessel, wherein a pressure test of the fluid vessel can be performed in-situ.

### TECHNICAL FIELD

The present invention relates to fuel cell power systems, and to methods of testing fuel cell power systems for gas leaks.

### BACKGROUND OF THE INVENTION

Fuel cells are well known in the art. A fuel cell is an electrochemical device which reacts a fuel and an oxidant to produce electricity and water. A typical fuel supplied to a fuel cell is hydrogen, and a typical oxidant supplied to a fuel cell is oxygen (or ambient air). Other fuels or oxidants can be employed depending upon the operational conditions.

The basic process in a fuel cell is highly efficient, and for those fuel cells fueled directly by hydrogen, pollution free. Further, since fuel cells can be assembled into stacks of various sizes, power systems have been developed to produce a wide range of electrical power outputs and thus can be employed in numerous commercial applications. The teachings of prior art patents, U.S. Pat. Nos. 4,599,282; 4,590,135; 4,599,282; 4,689,280; 5,242,764; 5,858,569; 5,981,098; 6,013,386; 6,017,648; 6,030,718; 6,040,072; 6,040,076; 6,096,449; 6,132,895; 6,171,720; 6,207,308; 6,218,039; 6,261,710 are incorporated by reference herein.

A fuel cell produces an electromotive force by reacting fuel and oxygen at respective electrode interfaces which share a common electrolyte.

In a fuel cell, fuel such as hydrogen gas is introduced at a first electrode (anode) where it reacts electrochemically in the presence of a catalyst to produce electrons and protons. The electrons are circulated from the first electrode to a second electrode (cathode) through an electrical circuit which couples these respective electrodes. Further, the protons pass through an electrolyte to the second electrode (cathode). Simultaneously, an oxidant, such as oxygen gas, (or air), is introduced to the second electrode where the oxidant reacts electrochemically in the presence of the catalyst and is combined with the electrons from the electrical circuit and the protons (having come across the electrolyte) thus forming water.

This reaction further completes the electrical circuit.

The following half cell reactions take place:

H₂→2H⁺+2e− (1)

(½)O₂+2H⁺+2e−→H₂O (2)

As noted above the fuel-side electrode is the anode, and the oxygen-side electrode is the cathode. The external electric circuit conveys the generated electrical current and can thus extract electrical power from the cell. The overall fuel cell reaction produces electrical energy which is the sum of the separate half cell reactions occurring in the fuel cell less its internal losses.

Experience has shown that a single fuel cell membrane electrode assembly of one design produces a useful voltage of only about 0.45 to about 0.7 volts D.C. under a load. In view of this, practical fuel cell power plants have been assembled from multiple cells stacked together such that they are electrically connected in series. Prior art fuel cells are typically configured as stacks, and have electrodes in the form of conductive plates. The conductive plates come into contact with one another so the voltages of the fuel cells electrically add in series. As would be expected, the more portions that are added to the stack, the greater the output voltage.

For example, U.S. Pat. No. 5,972,530 to Shelekhin et al. (incorporated herein by reference) describes a fuel cell stack configuration including bipolar fluid flow plates. Membrane electrode assemblies (MEAs) are sandwiched between respective pairs of bipolar fluid flow plates. Each membrane electrode assembly includes a polymer electrolyte membrane (PEM), and electrode material on each side of the PEM. In one embodiment, the polymer electrolyte membrane (PEM) is thin, flexible, and sheet-like and made from any material suitable for use as a polymer electrolyte membrane, e.g., Nafion (TM) fluoropolymer, available from Dupont, or SPE available from Asahi Chemical Industry Company. The electrode material on one side of the polymer electrolyte membrane defines an anode and the electrode material on the other side of the polymer electrolyte membrane defines a cathode. The anode is in contact with the anode side of one fuel flow plate in the stack and the cathode is in contact with the cathode side of another fuel flow plate in the stack.

Fuel cell systems including modules are also known in the art. See, for example, U.S. Pat. No. 6,218,035 to Fuglevand et al. (incorporated herein by reference). The Fuglevand et al. patent discloses a proton exchange membrane fuel cell power system including a plurality of discrete fuel cell modules having multiple membrane electrode diffusion assemblies. Each of the membrane electrode diffusion assemblies have opposite anode and cathode sides. Current collectors are individually disposed in juxtaposed ohmic electrical contact with opposite anode and cathode sides of each of the membrane electrode diffusion assemblies. Individual force application assemblies apply a given force to the current collectors and the individual membrane electrode diffusion assemblies. The proton exchange membrane fuel cell power system also includes an enclosure mounting a plurality of subracks which receive the discrete fuel cell modules.

A primary challenge in manufacturing fuel cells of all types is sealing active areas from fuel or oxidant leaks. There are many technologies for improving seals.

It is known to pressure test vessels for leaks. One technique is a “pressure decay” method wherein the vessel is pressurized and a pressure transducer is used to measure pressure loss over a fixed time period. If the loss exceeds a specified parameter, the vessel is indicated as having a leak. For example, U.S. Pat. No. 5,872,950 to Woodbury et al. (incorporated herein by reference) discloses a system and method of detecting leaks in a fuel gas delivery piping system, as typically found in a furnace or boiler. A processor or control system is used to sequentially pressurize a section or sections of the piping with gas, via associated valve or valves, and then monitor the charged piping pressure decay using a pressure transducer. Lamps or other signals are used to indicate test results.

U.S. Pat. No. 4,953,396 to Langsdorf et al. relating to a method of detecting a leak in an irregular container. A microprocessor-based control unit is used to automate the testing process. During testing, a container under test is pressurized by a source via a fill solenoid valve, and once at pressure, the fill valve is closed so as to isolate the container from the pressure source. Pressure in the container is then continuously measured using a pressure transducer connected to the microprocessor. Container pressure decay is compared to a reference pressure decay curve stored in ROM. Accept/Reject type indications are provided by the control unit, with a Reject indication given in the event that container pressure decay does not favorably compare to the reference curve stored in the ROM memory. A vent solenoid valve is later opened by the microprocessor to bleed the residual test pressure from the container.

U.S. Pat. No. 4,587,619 to Converse, III et al. (incorporated herein by reference) relates to a system and method for testing parts. Either pressure or vacuum can be applied to the part under test. A microcomputer-based control system is used to automate the test sequence.

U.S. Pat. No. 5,526,679 to Filippi et al. (incorporated herein by reference) relates to a system for detecting leaks in a piping system leading from an underground storage tank (such as for gasoline at a retail sales station) to a pump or distribution nozzle. A pressure transducer is used in conjunction with a microprocessor for comparison of a pipeline pressure decay to a reference curve calculated by the microprocessor. Pressure decay can be correlated with a volumetric leakage rate (i.e., gallons per hour).

U.S. Pat. No. 5,557,965 to Fiechtner relates to a method and apparatus for leak detection in fluid transportation lines, such as for gasoline. A bleed line may actuated to simulate a line leak and test the detection apparatus.

The above mentioned leak detection references do not relate to fuel cell leak testing. References relating to leak detection in fuel cells typically relate to detecting leaks across polymer electrode membranes. For example, U.S. Pat. No. 6,156,447 to Bette et al. (incorporated herein by reference) relates to a method and system of detecting a leak in a membrane electrode of a fuel cell by purging the cell with nitrogen, filling the cathode gas area with oxygen and the anode gas area with hydrogen, then monitoring cell voltage to determine if a voltage drop indicative of a leak is measured. The purge and gas fill aspect of the test process is automated through a controller.

Testing fuel cells for leaks is usually a laboratory or production test performed off-line using bench test equipment. If a leak is detected in a fuel cell, the unit is shut down until it can be tested and serviced.

### BRIEF DESCRIPTION OF THE DRAWINGS

Preferred embodiments of the invention are described below with reference to the following accompanying drawings.

FIG. 1 is a block diagram of a fuel cell system embodying the invention.

FIG. 2 is a block diagram of a fuel cell system in accordance with an alternative embodiment of the invention.

FIG. 3 is a block diagram of a fuel cell system in accordance with another alternative embodiment of the invention.

FIG. 4 is a perspective view of a fuel cell system in which modules are defined by hand-removable cartridges.

FIG. 5 is a perspective view of a fuel cell stack that can be used as part of a fuel cell system in accordance with the invention.

FIG. 6 is a timing diagram indicating valve sequencing of a fuel cell system in accordance with one embodiment of the invention.

FIG. 7 is a timing diagram indicating valve sequencing of a fuel cell system in accordance with one embodiment of the invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

The present invention relates to a method of testing an electrochemical fuel cell for gas leaks, the method comprising providing a gas sensor in gas sensing relation to the fuel cell, and initiating a pressure test of the fuel cell in response to the gas sensor sensing more than a predetermined amount of a target gas.

Another aspect of the invention relates to a fuel cell power system comprising a fuel cell defining a fluid vessel having a fuel inlet and bleed outlet; a fuel valve upstream of the fuel inlet; a bleed valve downstream of the fuel outlet; and a pressure transducer in fluid communication with the fluid vessel, wherein a pressure test of the fluid vessel is selectively performed in-situ.

Yet another aspect of the invention relates to a fuel cell power system comprising a fuel cell defining a fluid vessel having a fuel inlet and bleed outlet; a fuel valve upstream of the fuel inlet; a bleed valve downstream of the fuel outlet; and a pressure transducer in fluid communication with the fluid vessel, wherein a pressure test of the fluid vessel can be performed in-situ.

Another aspect of the invention relates to a method of testing a fuel cell for leaks, the fuel cell having a fuel valve and a bleed valve, the method comprising using the fuel valve and bleed valve to perform an in-situ pressure decay leak test on the fuel cell using the fuel valve and bleed valve.

A further aspect of the invention relates to a method of testing a hydrogen fuel cell system in-situ for a hydrogen leak, the hydrogen fuel cell system including a main fuel valve, a main bleed outlet, auxiliary fuel valves in fluid communication with the main valve and downstream from the main valve, auxiliary bleed valves in fluid communication with the main bleed outlet and upstream from the main bleed outlet, a plurality of hydrogen fuel cell modules having respective fuel inlets coupled to the auxiliary fuel valves and having respective outlets coupled to the auxiliary bleed valves, the method comprising providing a pressure transducer; providing a hydrogen sensor in gas sensing relation to the fuel cell system; and, in response to the hydrogen sensor sensing a hydrogen gas concentration above a predetermined threshold, identifying which module is leaking by controlling the auxiliary fuel and auxiliary bleed valves to pressure test one module at a time by supplying fuel to the tested module, while the auxiliary bleed valve for the tested module is closed, until the pressure of the tested module reaches a predetermined level, then discontinuing the supply of fuel to the tested module and monitoring if pressure of the tested module drops by more than a predetermined amount during a predetermined amount of time.

Another aspect of the invention relates to a hydrogen fuel cell system comprising a main fuel valve; a main bleed outlet; a plurality of auxiliary fuel valves in fluid communication with the main valve and downstream from the main valve; a plurality of auxiliary bleed valves in fluid communication with the main bleed outlet and upstream from the main bleed outlet; a plurality of hydrogen fuel cell modules having respective fuel inlets coupled to the auxiliary fuel valves, having respective outlets coupled to the auxiliary bleed valves, and having respective polymer electrolyte membranes between the fuel inlets and fuel outlets; at least one pressure transducer downstream of the main fuel valve and upstream of the main bleed outlet; a hydrogen sensor in gas sensing relation to the fuel cell modules; and a controller coupled in controlling relation to the main and auxiliary fuel and bleed valves and configured to, in response to the hydrogen sensor sensing a hydrogen gas concentration above a predetermined threshold, identify which module is leaking by controlling the auxiliary fuel and auxiliary bleed valves to pressure test one module at a time by supplying fuel to the tested module, while the auxiliary bleed valve for the tested module is closed, until the pressure of the tested module reaches a predetermined level, then discontinuing the supply of fuel to the tested module and monitoring if pressure of the tested module drops by more than a predetermined amount during a predetermined amount of time.

Another aspect of the invention provides a method of testing a fuel cell system in-situ for gas leaks, the fuel cell system including a main fuel valve, a main bleed outlet, auxiliary fuel valves in fluid communication with the main valve and downstream from the main valve, auxiliary bleed valves in fluid communication with the main bleed outlet and upstream from the main bleed outlet, a plurality of hydrogen fuel cell sub-systems having respective fuel inlets coupled to the auxiliary fuel valves and having respective outlets coupled to the auxiliary bleed valves, the method comprising providing a pressure transducer for each sub-system; and controlling the auxiliary fuel and auxiliary bleed valves to pressure test certain of the sub-systems one at a time by supplying fuel to the tested sub-system, while the auxiliary bleed valve for the tested sub-system is closed, until the pressure of the tested sub-system reaches a predetermined level, then discontinuing the supply of fuel to the tested sub-system and monitoring if pressure of the tested sub-system drops by more than a predetermined amount during a predetermined amount of time using the pressure transducer for the sub-system being tested.

Yet another aspect of the invention relates to a fuel cell system comprising a main fuel valve; a main bleed outlet; a plurality of auxiliary fuel valves in fluid communication with the main valve and downstream from the main valve; a plurality of auxiliary bleed valves in fluid communication with the main bleed outlet and upstream from the main bleed outlet; a plurality of fuel cell sub-systems having respective fuel inlets coupled to the auxiliary fuel valves, having respective outlets coupled to the auxiliary bleed valves, and having respective polymer electrolyte membranes between the fuel inlets and fuel outlets; a pressure transducer in pressure sensing relation to each fuel cell sub-system; and a controller coupled in controlling relation to the main and auxiliary fuel and bleed valves and configured to control the auxiliary fuel and auxiliary bleed valves to pressure test certain of the sub-systems one at a time by supplying fuel to the tested sub-system, while the auxiliary bleed valve for the tested sub-system is closed, until the pressure of the tested sub-system reaches a predetermined level, then discontinuing the supply of fuel to the tested sub-system and monitoring if pressure of the tested sub-system drops by more than a predetermined amount during a predetermined amount of time using the pressure transducer that is in pressure sensing relation to the sub-system being tested.

One aspect of the invention provides a system wherein a fuel cell is automatically pressure tested for leaks either in response to an alarm or as part of a regular programmed maintenance cycle. When applied to a modular fuel cell configuration, minimal additional equipment is required since existing valves and sensors may be used. A pressure transducer is installed in series with the main fuel valve which feed auxiliary valves that server each fuel cell module or cartridge. The pressure transducer may alternatively be installed in series with a bleed valve. A controller or fuel cell operating system opens the feed valve and allows it to come to full pressure. the pressure transducer then measures the leak rate over a fixed period of time.

In one aspect of the invention, a controller is used to identify and isolate the source of a fuel or oxidant leak in a modular fuel cell system. In this aspect, the fuel cell system is shut down in response to a leak detected by an onboard sensor. To facilitate isolation of the leak, the system automatically begins to pressure test each module or cartridge as described above. When the transducer measures a high leak rate, that cartridge is taken out of service by shunting its electrical output and shutting off its fuel and oxidant supply. The fuel cell system can then be re-energized, except for the failed module, and it continues to operate unless another leak is detected (in which case another pressure test is initiated).

In another aspect of the invention, a controller is used to periodically test different modules of a fuel cell system, while it operates, as part of an automated maintenance schedule. In this aspect, a separate transducer is provided for each module that can be taken down individually without impacting service to the load.

For example, a four-module fuel cell system has four transducers, and each module is temporarily removed from service during the test. The controller may be programmed to perform this test during historically low-load times. To test a module, it is first taken out of service. The bleed valve is closed, the electrical output is shunted, and the fuel valve is opened to allow the module to pressurize. The pressure decay leak test is performed, and if the pressure decay is below acceptable limits, the fuel cell module is placed back in service. If the decay limit is exceeded, the fuel cell module remains out of service, and an error message is communicated.

In one embodiment, if a module fails a pressure test, a message is communicated to a service company via a telephone link (or via the Internet, via a pager, or other electronic messaging) so that a service call can be requested automatically. Thus, the fuel cell system 10 can be serviced before full load is required, thus preventing an interruption of service.

These and other aspects of the present invention will be discussed hereinafter.

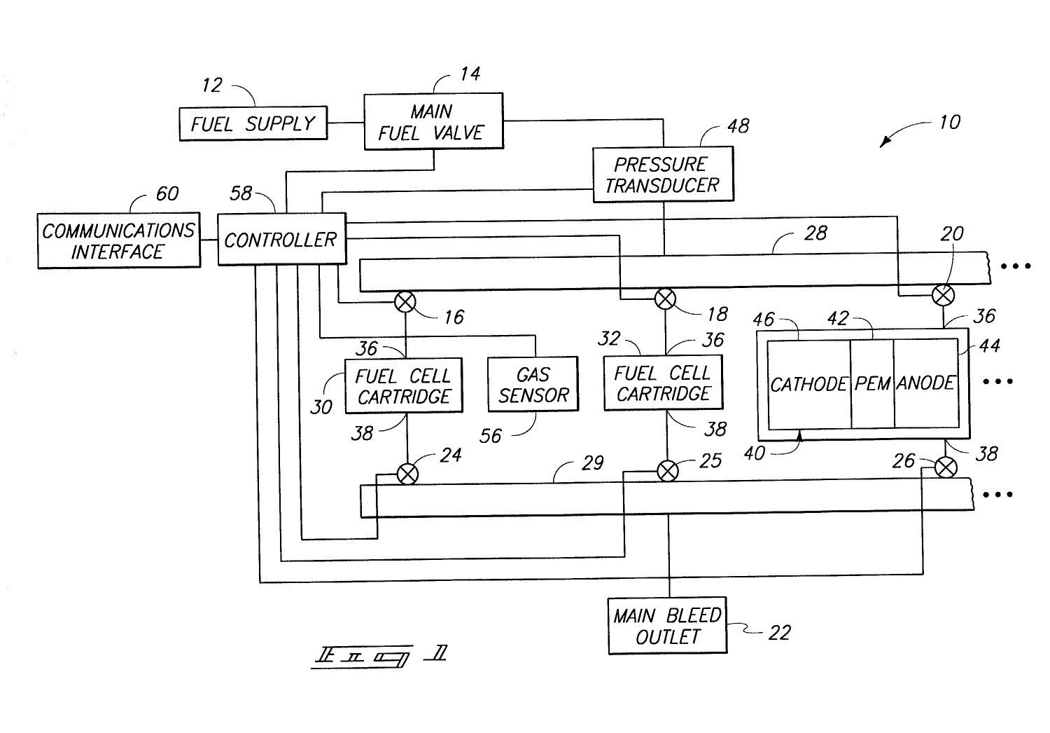

FIG. 1 shows a fuel cell system 10 in accordance with one embodiment of the invention. In the illustrated embodiment, the fuel cell system 10 is a hydrogen fuel cell system that uses a supply 12 of hydrogen gas or hydrogen-rich gas (reformed hydrogen) as fuel; however, in alternative embodiments, the fuel cell system 10 uses another type of gas fuel.

The fuel cell system 10 includes a main fuel valve 14. The fuel cell system 10 further includes a plurality (any appropriate number) of auxiliary fuel valves 16, 18, and 20 in fluid communication with the main fuel valve 14 and downstream from the main fuel valve 14. The fuel cell system 10 also includes a main bleed outlet 22, and a plurality of auxiliary bleed valves 24, 25, and 26 in fluid communication with the main bleed outlet 22 and upstream from the main bleed outlet 22.

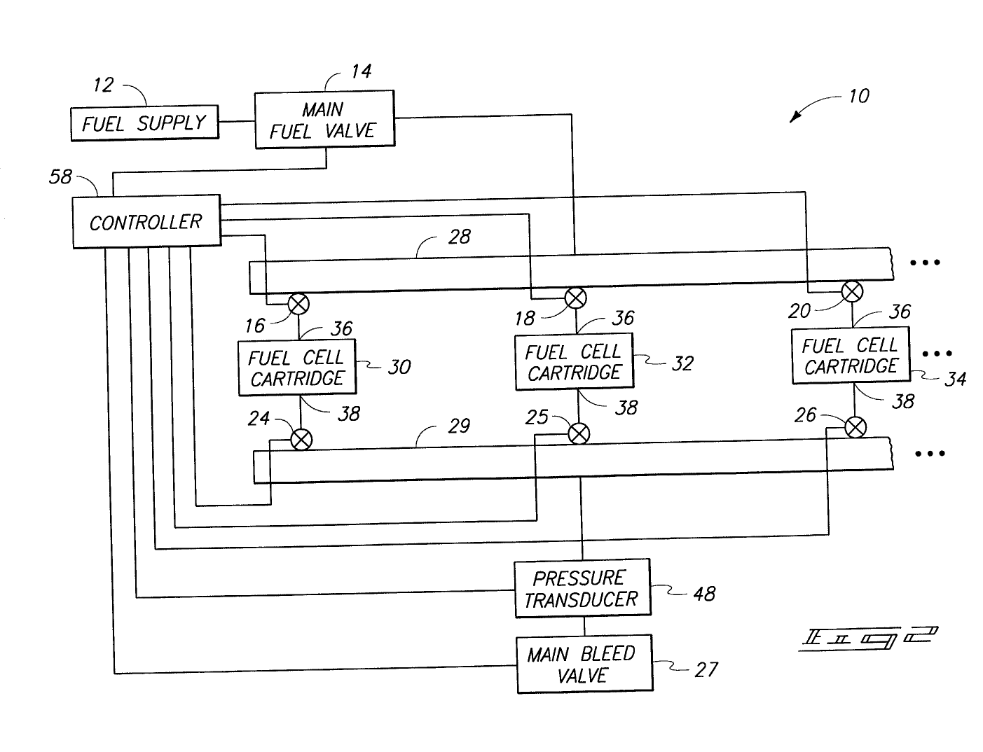

In one embodiment, shown in FIG. 2, the fuel cell system 10 includes a main bleed valve 27 defining the main bleed outlet. The fuel cell system 10 includes a fuel header or manifold 28 between the main fuel valve 14 and the auxiliary fuel valves 16, 18, and 20, for supplying fuel to the auxiliary fuel valves 16, 18, and 20. The fuel cell system 10 further includes a bleed header or manifold 29 in fluid communication with the auxiliary bleed valves 24, 25, and 26.

The fuel cell system 10 further includes a plurality of hydrogen fuel cells, fuel cell subsystems, or fuel cell modules 30, 32, and 34 having respective fuel inlets 36 coupled to the auxiliary fuel valves 16, 18, and 20, and having respective outlets 38 coupled to the auxiliary bleed valves 24, 25, and 26.

The fuel cell modules 30, 32, and 34 include membrane electrode assemblies (MEAs) 40 between the fuel inlets 36 and fuel outlets 38. Each membrane electrode assembly 40 includes (see FIG. 1) a polymer electrolyte membrane (PEM), ion exchange membrane, or proton exchange membrane 42, and electrode layers on each side of the PEM defining an anode 44 and a cathode 46.

In one embodiment, the polymer electrolyte membrane (PEM) 42 is thin, flexible, and sheet-like and made from any material suitable for use as a polymer electrolyte membrane, e.g., Nafion (TM) fluoropolymer, available from Dupont, or SPE available from Asahi Chemical Industry Company.

During operation of fuel cell modules, non-fuel diluents such as cathode-side water and atmospheric constituents can diffuse from the cathode side of the membrane electrode assembly 40 and accumulate in the anode side of the membrane electrode assembly 40. In addition, impurities in the fuel supply delivered directly to the anode side also accumulate. Without intervention, these diluents can dilute the fuel sufficiently enough to degrade performance. Accordingly, the anode sides of the modules 30, 32, and 34 are connected to auxiliary bleed valves 24, 25, and 26, respectively. In one embodiment, individual auxiliary bleed valves 24, 25, and 26 are omitted, and a single main bleed valve 27 is used instead.

The fuel cell system 10 further includes conduits (not shown) for supplying oxidant (e.g. air) to the cathodes of the modules 30, 32, and 34. In hydrogen fuel cells, the oxidant used is typically air, and therefore testing for leaks of oxidant may not be as important as testing for fuel leaks so testing for leaks of oxidant may be omitted.

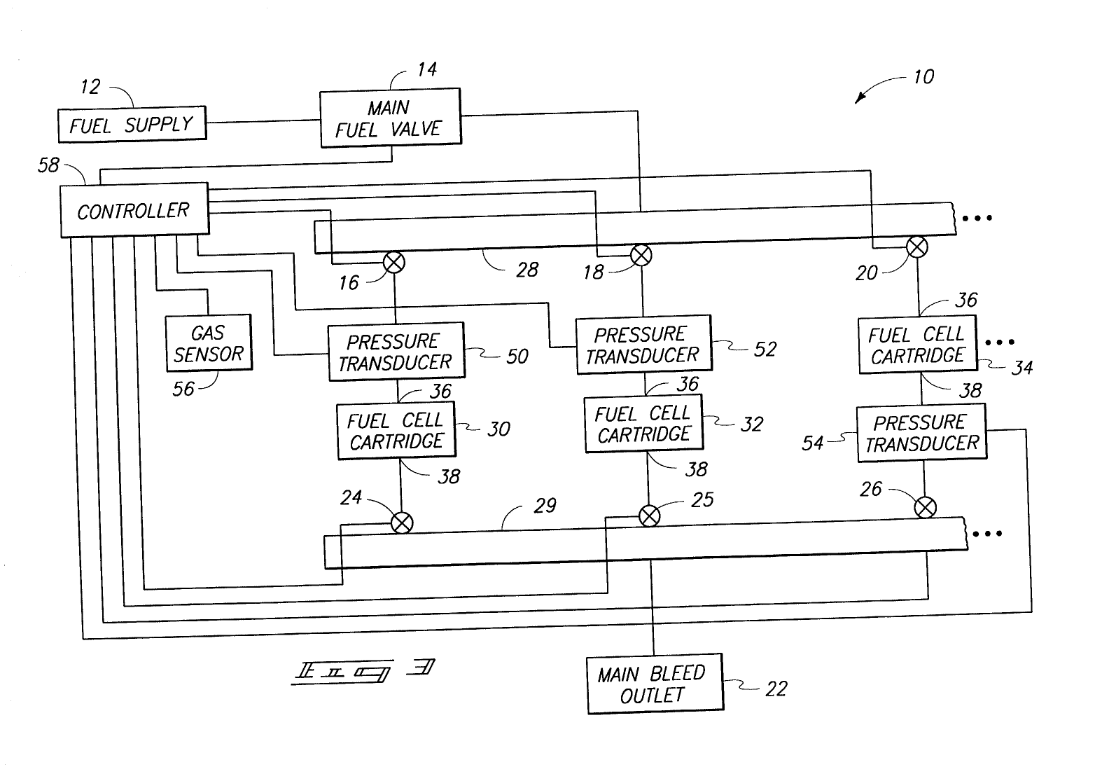

The fuel cell system 10 further includes at least one pressure transducer 48 downstream of the main fuel valve 14 and upstream of the main bleed outlet 22. In one embodiment (see FIGS. 1 and 2), only one pressure transducer 48 is employed for multiple modules 30, 32, and 34; however, in an alternative embodiment, multiple pressure transducers 50, 52, and 54 are employed (see FIG. 3); e.g., one pressure transducer per module 30, 32, and 34.

In one embodiment, the fuel cell system 10 further includes at least one gas sensor 56 in gas sensing relation to the fuel cell modules 30, 32, and 34. The gas sensor 56 provides an electrical output signal that is representative of concentration of a target gas the sensor is configured to sense. In one embodiment, the gas sensor 56 is designed to sense fuel gas; e.g., hydrogen. In one embodiment, a gas sensor designed to sense concentration of the oxidant used by the modules 30, 32, and 34 is provided in addition or instead of the gas sensor 56 designed to sense fuel. In one embodiment, the fuel cell system 10 includes a gas sensor or gas sensor system such as disclosed in any of the following applications by Greg A. Lloyd et al., which are incorporated herein by reference: U.S. patent application Ser. No. 09/854,059, filed May 11, 2001, and titled “Method of Detecting Poisoning of a MOS Gas Sensor,” U.S. patent application Ser. No. 09/854,056, filed May 11, 2001, and titled “Method for Quickly Rendering a MOS Gas Sensor Operational, MOS Gas Sensor System, and Fuel Cell System”; and U.S. patent application Ser. No. 09/916,850, filed Jul. 26, 2001, and titled “Method of Compensating a MOS Gas Sensor, Method of Manufacturing a MOS Gas Sensor, MOS Gas Sensor, and Fuel Cell System.” In another alternative embodiment, the gas sensor 56 is omitted.

The fuel cell system 10 further includes a controller 58 coupled in controlling relation to the main and auxiliary fuel and bleed valves 14, 16, 18, 20, 24, 25, and 26 (and 27, if included). For example, in one embodiment, the valves 14, 16, 18, 20, 24, 25, and 26 and 27 are electrically controllable. The valves may only have on or off conditions, or may be variably or infinitely controllable. The controller 58 is electrically coupled to the pressure transducer 48 and, if provided, to the gas sensor 56. In one embodiment, the controller 58 comprises a programmable logic array, embedded controller, processor, microprocessor, etc.

In one embodiment, the controller 58 effects a pressure decay test in response to the sensor 56 sensing a gas concentration above a predetermined threshold.

In an alternative embodiment, the controller 58 effects a pressure decay test as part of a routine maintenance cycle, periodically, upon demand, or in accordance with a specified schedule. In this alternative embodiment, the controller 58 includes a timer.

In one embodiment, the controller 58 performs the pressure decay test by controlling the various valves 14, 16, 18, 20, 24, 25, and 26 and 27 to pressure test one module 30, 32, or 34 at a time. The pressure test comprises supplying fuel to the tested module, until the pressure of the tested module 30, 32, or 34 reaches a predetermined level, then discontinuing the supply of fuel to the tested module 30, 32, or 34 and monitoring if pressure of the tested module 30, 32, or 34, as measured by the pressure transducer 48, 50, 52, or 54 drops by more than a predetermined amount during a predetermined amount of time. In one embodiment, the pressure decay test comprises testing each of the modules 30, 32, and 34; e.g., in a sequence. The sequence can be to first test a first module 30, then a second module 32, then a third module 34, for example. Any number of modules can be provided in the fuel cell system 10 and any order can be used.

In one embodiment, the system includes a dialer or e-mail, paging, or other communication interface 60 electrically coupled to the controller 58. If a module fails a pressure test, a message is communicated to a service company using the communication interface via telephone (or via the Internet, via a pager, or other electronic messaging) so that a service call can be initiated automatically. For example, if a dialer is used, a call can be initiated, and a prerecorded message can be played when the call is answered. Multiple redial attempts can be made if the call is not answered within a predetermined amount of time or predetermined number of rings. A prerecorded message or e-mail could indicate, for example, that service is required, the location of the fuel cell system, and which of the modules has failed the pressure test. Alternatively, a code could be communicated indicative of the failure of a module during a pressure test. Thus, the fuel cell system 10 can be serviced before full load is required, thus preventing an interruption of service.

In the embodiment shown in FIG. 1, the pressure transducer 48 is downstream of the main fuel valve 14 and upstream of the auxiliary fuel valves 16, 18, and 20. In this embodiment, a single, common pressure transducer 48 is used to test multiple or all of the modules 30, 32, and 34.

In the embodiment shown in FIG. 2, the pressure transducer 48 is upstream of the main bleed valve 27 and downstream of the auxiliary bleed valves 24, 25, and 26. In this embodiment, a single, common pressure transducer 48 is used to test multiple or all of the modules 30, 32, and 34.

In the embodiment shown in FIG. 3, a pressure transducer is provided for each module 30, 32, and 34. This allows operation of other modules to continue while one module is being pressure tested.

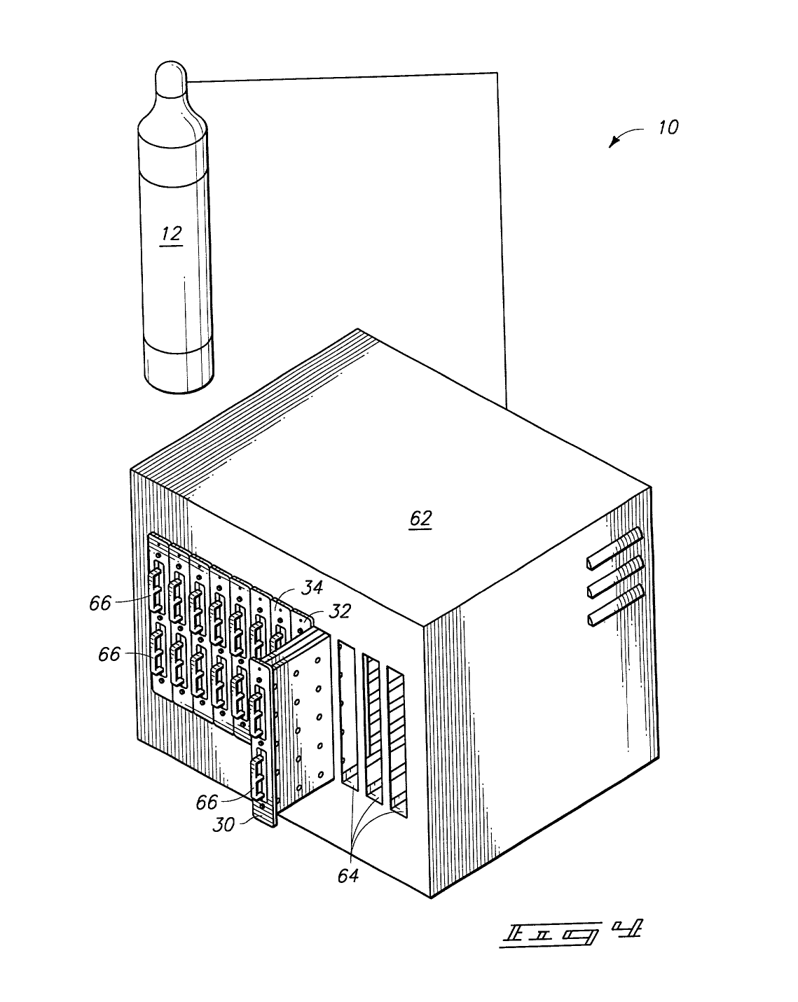

In one embodiment, shown in FIG. 4, the fuel cell system 10 further includes a rack 62 defining a plurality of compartments 64 respectively in fluid communication with auxiliary fuel and bleed valves, such as is described in U.S. patent application Ser. No. 09/322,666 filed May 28, 1999, listing as inventors Fuglevand et al., and incorporated by reference herein. In this embodiment, the modules 30, 32, and 34 are cartridges that are removable from the rack 62 by hand, and that include handles 66 for that purpose.

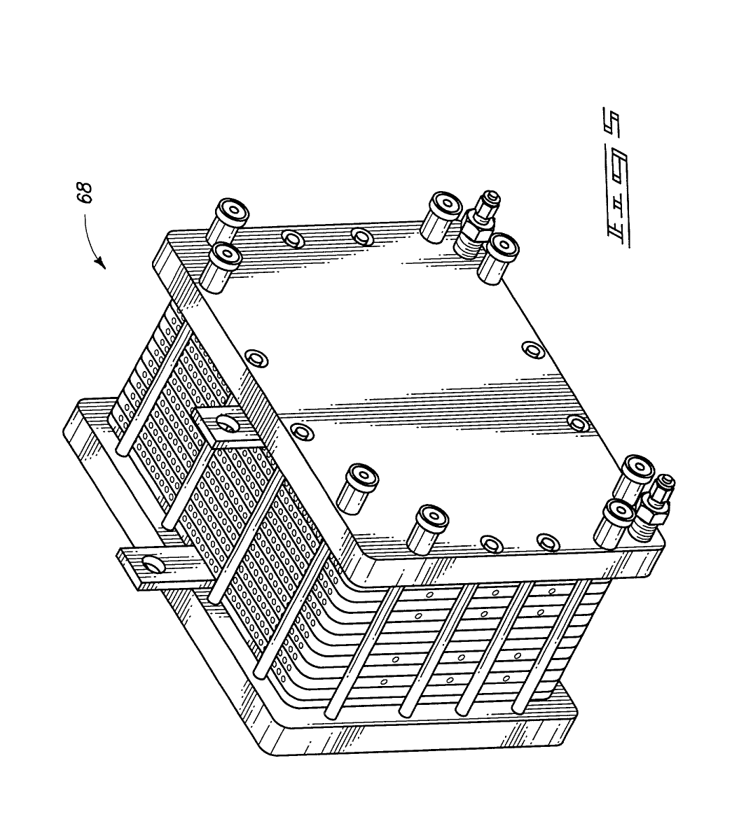

In an alternative embodiment, the modules 30, 32, and 34 are respective fuel cell stacks 68, one example of which is shown in FIG. 5 (or portions of stacks if separate fuel feeds are provided to separate sections of a stack).

### Operation

In operation, when the modules 30, 32, and 34 are not being tested, a fuel supply e.g., a supply of hydrogen gas 12, is disposed in fluid communication with the main fuel valve 14 and fuel is transmitted via the fuel header 28 to the modules 30, 32, and 34, to the anode side of each of the membrane electrode assemblies 40. The hydrogen gas reacts electrochemically in the presence of the catalyst to produce electrons and protons. The electrons travel from the anode 44 to the cathode 46, through an electrical circuit connected between the anode 44 and cathode 46. Further, the protons pass through the polymer electrolyte membrane 42 to the cathode 46. Simultaneously, an oxidant, such as oxygen gas, (or air), is introduced to or available at the cathode 46 where the oxidant reacts electrochemically and is combined with the electrons from the electrical circuit and the protons (having come across the proton exchange membrane) thus forming water and completing the electrical circuit. The auxiliary bleed valves 24, 25, and 26 are normally open or can be normally closed and pulsed open periodically or upon build-up of waste water.

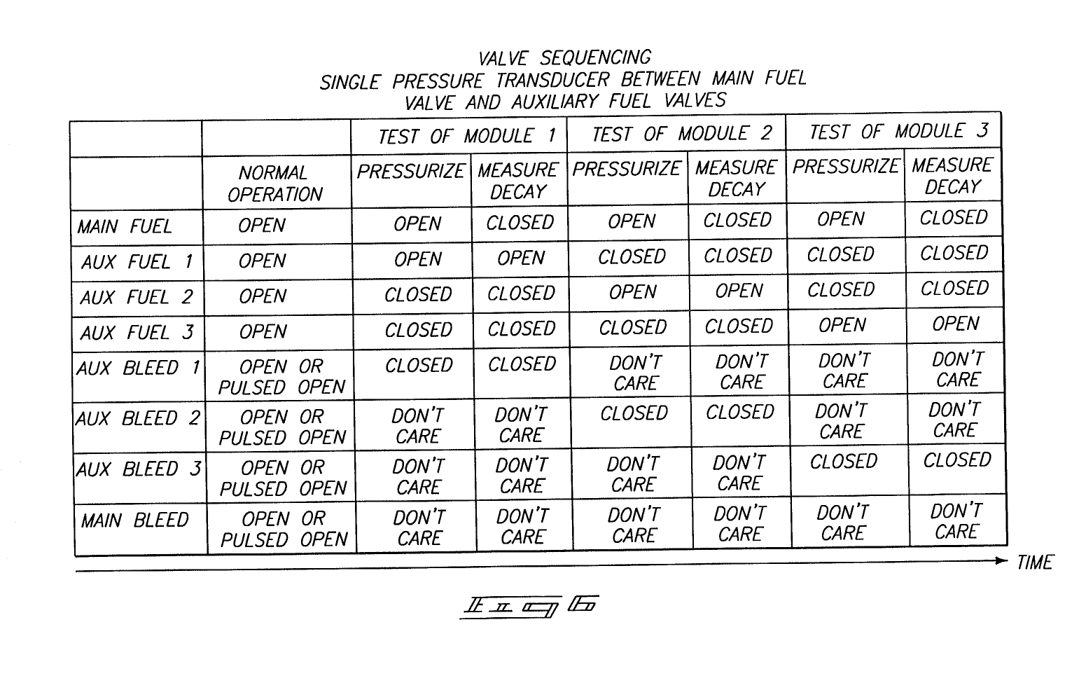

FIG. 6 illustrates one possibility for valve sequencing for the FIG. 1 embodiment where the pressure transducer 48 is downstream of the main fuel valve 14 and upstream of the auxiliary fuel valves 16, 18, and 20. In operation, the controller 58 controls the valves to perform the pressure test by supplying fuel to the tested module, while the auxiliary bleed valve 24, 25, or 26 for the tested module 30, 32, or 34 is closed and the other auxiliary fuel valves 16, 18, and 20 are closed, until the pressure of the tested module 30, 32, or 34 reaches the predetermined level (e.g., full pressure or, for example, about 5 PSI, or some other desired pressure), then discontinuing the supply of fuel to the tested module 30, 32, or 34 by closing the main fuel valve 14 while the auxiliary bleed valve 24, 25, or 26 for the tested module 30, 32, or 34 is closed, while the auxiliary fuel valve 16, 18, or 20 for the tested module 30, 32, or 34 is open, and while the other auxiliary fuel valves 16, 18, and 20 are closed and monitoring if pressure of the tested module 30, 32, or 34 drops by more than a predetermined amount (e.g., by more than 5 percent, 10 percent, 20 percent, 30 percent, 50 percent or any other amount sufficient to be deemed to be unacceptable or dangerous or meriting an alarm) during a predetermined amount of time (e.g., thirty seconds, one minute, two minutes, or some other appropriate amount of time).

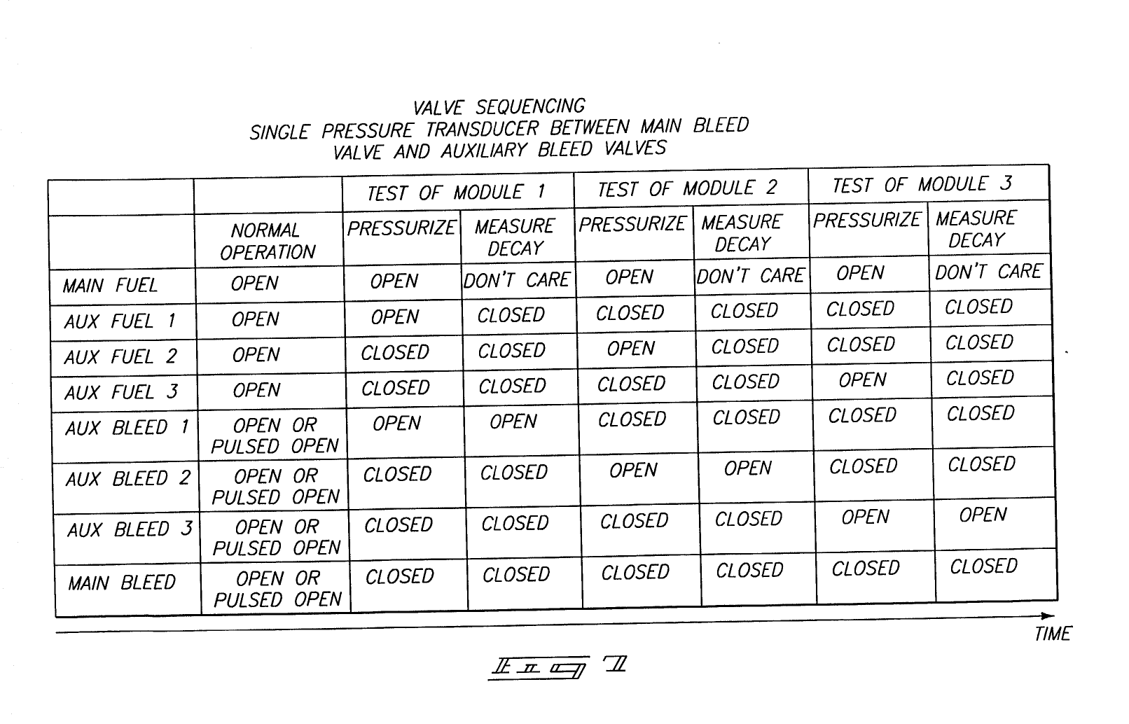

FIG. 7 illustrates one possibility for valve sequencing for the FIG. 2 embodiment where the pressure transducer 60 is upstream of the main bleed outlet 22 and downstream of the auxiliary bleed valves 24, 25, and 26. In operation, the controller 58 controls the valves to perform the pressure test. Fuel is supplied fuel to the tested module, while the main bleed valve 27 is closed (or the auxiliary bleed valve 24, 25, or 26 for the module 30, 32, or 34 being tested is closed) and while all the auxiliary fuel valves 16, 18, and 20 (or all the auxiliary bleed valves 24, 25, and 26) are closed except for the one for the module 30, 32, or 34 being tested. After the pressure of the tested module 30, 32, or 34 reaches the predetermined level (e.g., full pressure or, for example, about 5 PSI, or some other desired pressure), the supply of fuel to the tested module 30, 32, or 34 is discontinued. This can be done, for example, by closing the auxiliary fuel valve 16, 18, or 20 for the module 30, 32, or 34 being tested, or by closing the main fuel valve 14 while the auxiliary fuel valves 16, 18, and 20 for the non-tested modules 30, 32, or 34 are closed. Then, the auxiliary bleed valve 24, 25, or 26 for the tested module 30, 32, or 34 is opened (or left open) and the auxiliary bleed valves 24, 25, and 26 for the non-tested modules 30, 32, or 34 are closed (or left closed) while the main bleed valve 27 is closed. Then, the controller 58 monitors if pressure of the tested module 30, 32, or 34 drops by more than a predetermined amount (e.g., by more than 5 percent, 10 percent, 20 percent, 30 percent, 50 percent or any other amount sufficient to be deemed to be unacceptable or dangerous or meriting an alarm) during a predetermined amount of time (e.g., thirty seconds, one minute, two minutes, or some other appropriate amount of time).

In alternative embodiments, the tested module 30, 32, or 34 is pressurized using oxidant, on the cathode side of each module, instead of or in addition to pressure testing with fuel. To pressure test using oxidant, appropriate valves would have to be included on the cathode side of each module.

In certain embodiments (see FIG. 3), while the controller 58 effects testing of one module, the controller 58 causes fuel to be supplied to other modules 30, 32, or 34, and those other sub-systems continue to operate. This is possible if a separate pressure transducer is provided for each of the modules 30, 32, and 34, or if auxiliary bleed valves 24, 25, and 26 are pulsed; e.g., after a module 30, 32, or 34 is tested.

Thus, a system has been provided wherein a fuel cell is automatically pressure tested for leaks either in response to an alarm or as part of a regular programmed maintenance cycle. When applied to a modular fuel cell configuration, minimal additional equipment is required since existing valves and sensors may be used. A pressure transducer is installed in series with the main fuel valve which feed auxiliary valves that serve each fuel cell module or cartridge. The pressure transducer may alternatively be installed in series with a bleed valve. A controller or fuel cell operating system opens the feed valve and allows it to come to full pressure. The pressure transducer then measures the leak rate over a fixed period of time.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A method of testing an electrochemical fuel cell for gas leaks, the method comprising providing a gas sensor in gas sensing relation to the fuel cell, and initiating a pressure test of the fuel cell in response to the gas sensor sensing more than a predetermined amount of a target gas.

2. A method in accordance with claim 1 wherein the fuel cell is a polymer electrolyte membrane type fuel cell.

3. A method in accordance with claim 1 wherein the target gas sensed by the gas sensor is fuel gas for the fuel cell.

4. A method in accordance with claim 1 wherein the fuel cell is of a type that uses hydrogen-rich gas as a fuel source and wherein the target gas sensed by the gas sensor is hydrogen.

5. A method in accordance with claim 1 wherein the pressure test is performed in-situ.

6. A method in accordance with claim 2 wherein the pressure test is performed in-situ using fuel gas.

7. A method in accordance with claim 1 wherein the fuel cell has an anode side having a fuel inlet and a bleed valve, and a cathode side, and wherein the pressure test is performed in-situ, using fuel, on the anode side.

8. A method in accordance with claim 7 wherein the pressure test is performed in-situ using fuel and using existing fuel and bleed valves of the fuel cell system.

9. A method in accordance with claim 7 wherein the pressure test is performed in-situ using fuel and using a pressure transducer placed in fluid communication with existing fuel and bleed valves.

10. A fuel cell power system comprising:
a fuel cell defining a fluid vessel having a fuel inlet and bleed outlet;
a fuel valve upstream of the fuel inlet;
a bleed valve downstream of the fuel outlet; and
a pressure transducer in fluid communication with the fluid vessel, wherein a pressure test of the fluid vessel is selectively performed in-situ.

11. A fuel cell power system in accordance with claim 10 wherein the fuel cell comprises a polymer electrolyte membrane.

12. A fuel cell power system in accordance with claim 10 wherein the fuel cell is a hydrogen fuel cell.

13. A fuel cell power system in accordance with claim 10 and further comprising a controller in controlling relation to the fuel and bleed valves, and in communication with the pressure transducer, and configured to effect a pressure test on the fuel cell by controlling the fuel and bleed valves and based on pressure change over time using the pressure transducer.

14. A fuel cell power system in accordance with claim 13 wherein fuel is used to pressure test the fuel cell.

15. A fuel cell power system in accordance with claim 13 wherein the controller periodically performs a pressure test.

16. A fuel cell power system in accordance with claim 13 and further comprising a gas sensor in gas sensing relation to the fuel cell and electrically coupled to the controller, wherein the controller effects a pressure test in response to the gas sensor sensing more than a predetermined amount of a target gas.

17. A fuel cell power system in accordance with claim 13 and further comprising a gas sensor in gas sensing relation to the fuel cell and electrically coupled to the controller, wherein the controller effects a pressure test in response to the gas sensor sensing more than a predetermined amount of fuel gas.

18. A method of testing a fuel cell for leaks, the fuel cell having a fuel valve and a bleed valve, the method comprising using the fuel valve and bleed valve to perform an in-situ pressure decay leak test on the fuel cell using the fuel valve and bleed valve.

19. A method of testing a fuel cell in accordance with claim 18, wherein the fuel cell is a hydrogen fuel cell comprising a polymer electrolyte membrane.

20. A method of testing a fuel cell in accordance with claim 18 and further comprising providing a pressure transducer in pressure sensing relation to the vessel, and wherein the pressure decay leak test is performed using the pressure transducer.

21. A method of testing a fuel cell in accordance with claim 20, and further comprising normally operating the fuel cell with the pressure transducer in place, after the pressure decay leak test, if the pressure decay leak test does not indicate a leak at a rate higher than a predetermined maximum.

22. A method of testing a hydrogen fuel cell system in-situ for a hydrogen leak, the hydrogen fuel cell system including a main fuel valve, a main bleed outlet, auxiliary fuel valves in fluid communication with the main valve and downstream from the main valve, auxiliary bleed valves in fluid communication with the main bleed outlet and upstream from the main bleed outlet, a plurality of hydrogen fuel cell modules having respective fuel inlets coupled to the auxiliary fuel valves and having respective outlets coupled to the auxiliary bleed valves, the method comprising:
providing a pressure transducer;
providing a hydrogen sensor in gas sensing relation to the fuel cell system; and
in response to the hydrogen sensor sensing a hydrogen gas concentration above a predetermined threshold, identifying which module is leaking by controlling the auxiliary fuel and auxiliary bleed valves to pressure test one module at a time by supplying fuel to the tested module, while the auxiliary bleed valve for the tested module is closed, until the pressure of the tested module reaches a predetermined level, then discontinuing the supply of fuel to the tested module and monitoring if pressure of the tested module drops by more than a predetermined amount during a predetermined amount of time.

23. A method of testing a hydrogen fuel cell system in accordance with claim 22 wherein the pressure transducer is provided between the main fuel valve and the auxiliary fuel valves.

24. A method of testing a hydrogen fuel cell system in accordance with claim 23 wherein a common pressure transducer is used to test multiple of the modules.

25. A method of testing a hydrogen fuel cell system in accordance with claim 24 wherein the supply of fuel to the tested module is discontinued, during testing, by closing the main fuel valve while all auxiliary fuel valves are closed except the auxiliary fuel valve for the tested module.

26. A method of testing a hydrogen fuel cell system in accordance with claim 24 wherein the supply of fuel to the tested module is discontinued, during testing, by closing the main fuel valve while all auxiliary fuel and bleed valves are closed except the auxiliary fuel valve for the tested module.

27. A method of testing a hydrogen fuel cell system in accordance with claim 23 wherein a single pressure transducer is used to test all of the modules.

28. A method of testing a hydrogen fuel cell system in accordance with claim 22 wherein the pressure transducer is provided between the main bleed outlet and the auxiliary bleed valves.

29. A method of testing a hydrogen fuel cell system in accordance with claim 28 wherein a common pressure transducer is used to test multiple of the modules.

30. A method of testing a hydrogen fuel cell system in accordance with claim 22 wherein the modules are cartridges that are removable from a rack by hand.

31. A method of testing a hydrogen fuel cell system in accordance with claim 22 and further comprising, if a leak is detected for a tested module, supplying fuel to other modules and resuming operation of the fuel cell system by supplying fuel to those other modules.

32. A method of testing a hydrogen fuel system in accordance with claim 22 and further comprising, if a leak is detected for a tested module, transmitting a communication requesting maintenance.

33. A hydrogen fuel cell system comprising:
a main fuel valve;
a main bleed outlet;
a plurality of auxiliary fuel valves in fluid communication with the main valve and downstream from the main valve;
a plurality of auxiliary bleed valves in fluid communication with the main bleed outlet and upstream from the main bleed outlet;
a plurality of hydrogen fuel cell modules having respective fuel inlets coupled to the auxiliary fuel valves, having respective outlets coupled to the auxiliary bleed valves, and having respective polymer electrolyte membranes between the fuel inlets and fuel outlets;
at least one pressure transducer downstream of the main fuel valve and upstream of the main bleed outlet;
a hydrogen sensor in gas sensing relation to the fuel cell modules; and
a controller coupled in controlling relation to the main and auxiliary fuel and bleed valves and configured to, in response to the hydrogen sensor sensing a hydrogen gas concentration above a predetermined threshold, identify which module is leaking by controlling the auxiliary fuel and auxiliary bleed valves to pressure test one module at a time by supplying fuel to the tested module, while the auxiliary bleed valve for the tested module is closed, until the pressure of the tested module reaches a predetermined level, then discontinuing the supply of fuel to the tested module and monitoring if pressure of the tested module drops by more than a predetermined amount during a predetermined amount of time.

34. A hydrogen fuel cell system in accordance with claim 33 wherein the pressure transducer is downstream of the main fuel valve and upstream of the auxiliary fuel valves.

35. A hydrogen fuel cell system in accordance with claim 34 wherein a common pressure transducer is used to test multiple of the modules.

36. A hydrogen fuel cell system in accordance with claim 35 wherein a single pressure transducer is used to test all of the modules

37. A hydrogen fuel cell system in accordance with claim 33 wherein the pressure transducer is upstream of the main bleed outlet and downstream of the auxiliary bleed valves.

38. A hydrogen fuel cell system in accordance with claim 37 wherein a common pressure transducer is used to test multiple of the modules.

39. A hydrogen fuel cell system in accordance with claim 33 and further comprising a rack defining a plurality of compartments respectively in fluid communication with auxiliary fuel and bleed valves, and wherein the modules are cartridges that are removable from the rack by hand.

40. A method of testing a fuel cell system in-situ for gas leaks, the fuel cell system including a main fuel valve, a main bleed outlet, auxiliary fuel valves in fluid communication with the main valve and downstream from the main valve, auxiliary bleed valves in fluid communication with the main bleed outlet and upstream from the main bleed outlet, a plurality of hydrogen fuel cell sub-systems having respective fuel inlets coupled to the auxiliary fuel valves and having respective outlets coupled to the auxiliary bleed valves, the method comprising:
providing a pressure transducer for each sub-system; and
controlling the auxiliary fuel and auxiliary bleed valves to pressure test certain of the sub-systems one at a time by supplying fuel to the tested sub-system, while the auxiliary bleed valve for the tested sub-system is closed, until the pressure of the tested sub-system reaches a predetermined level, then discontinuing the supply of fuel to the tested sub-system and monitoring if pressure of the tested sub-system drops by more than a predetermined amount during a predetermined amount of time using the pressure transducer for the sub-system being tested.

41. A method of testing a fuel cell system in accordance with claim 40 wherein the one at a time pressure testing of sub-systems is sequential testing of all sub-systems.

42. A method of testing a fuel cell system in accordance with claim 40 wherein the sequential testing is performed periodically.

43. A method of testing a fuel cell system in accordance with claim 40 wherein the one at a time pressure testing of sub-systems is performed at scheduled times.

44. A method of testing a fuel cell system in accordance with claim 40 wherein the supply of fuel to the tested sub-system is discontinued by closing the auxiliary fuel valve for the tested sub-system while the main fuel valve is open.

45. A method of testing a fuel cell system in accordance with claim 40 wherein, while one sub-system is being tested, fuel is supplied to other sub-systems and those other sub-systems continue to operate.

46. A method of testing a fuel cell system in accordance with claim 45 wherein the sub-systems are cartridges that are removable from a rack by hand.

47. A method of testing a fuel cell system in accordance with claim 40 wherein fuel is used to perform the pressure tests.

48. A fuel cell system comprising:
a main fuel valve;
a main bleed outlet;
a plurality of auxiliary fuel valves in fluid communication with the main valve and downstream from the main valve;
a plurality of auxiliary bleed valves in fluid communication with the main bleed outlet and upstream from the main bleed outlet;
a plurality of fuel cell sub-systems having respective fuel inlets coupled to the auxiliary fuel valves, having respective outlets coupled to the auxiliary bleed valves, and having respective polymer electrolyte membranes between the fuel inlets and fuel outlets;
a pressure transducer in pressure sensing relation to each fuel cell sub-system; and
a controller coupled in controlling relation to the main and auxiliary fuel and bleed valves and configured to control the auxiliary fuel and auxiliary bleed valves to pressure test certain of the sub-systems one at a time by supplying fuel to the tested sub-system, while the auxiliary bleed valve for the tested sub-system is closed, until the pressure of the tested sub-system reaches a predetermined level, then discontinuing the supply of fuel to the tested sub-system and monitoring if pressure of the tested sub-system drops by more than a predetermined amount during a predetermined amount of time using the pressure transducer that is in pressure sensing relation to the sub-system being tested.

49. A fuel cell system in accordance with claim 48 wherein the controller effects sequential testing of all sub-systems.

50. A fuel cell system in accordance with claim 49 wherein the controller causes the sequential testing to be performed periodically.

51. A fuel cell system in accordance with claim 48 wherein the controller effects the one at a time pressure testing of sub-systems at scheduled times

52. A fuel cell system in accordance with claim 48 wherein the controller discontinues the supply of fuel to the tested sub-system by closing the auxiliary fuel valve for the tested sub-system while the main fuel valve is open and other auxiliary fuel valves are open.

53. A fuel cell system in accordance with claim 48 wherein, while the controller effects testing of one sub-system, the controller causes fuel to be supplied to other sub-systems and those other sub-systems continue to operate.

54. A fuel cell system in accordance with claim 53 and further comprising a rack defining a plurality of compartments respectively in fluid communication with auxiliary fuel and bleed valves, and wherein the sub-systems are cartridges that are removable from the rack by hand.

55. A fuel cell system in accordance with claim 48 and further comprising a communications interface coupled to the controller, wherein the controller effects a communication requesting service, using the communications interface, in response to the controller determining that a sub-system failed a leak test.

56. A fuel cell system in accordance with claim 55 wherein the communications interface comprises a dialer configured to call a number, and wherein the communications interface plays a prerecorded message when the call is answered, in response to the controller determining that a sub-system failed a leak test.

57. A fuel cell system in accordance with claim 55 wherein the communications interface sends an e-mail, in response to the controller determining that a sub-system failed a leak test.

58. A fuel cell system in accordance with claim 55 wherein the communications interface sends a page to a pager, in response to the controller determining that a sub-system failed a leak test.
